(19) United States
(12) Patent Application Publication
(10) Pub. No.: US 2018/0032358 A1
(43) Pub. Date: Feb. 1, 2018

(54) CROSS-ADDRESS SPACE OFFLOADING OF MULTIPLE CLASS WORK ITEMS

(71) Applicant: CA, Inc., New York, NY (US)

(72) Inventors: Frederic Armand Honore Duminy, St. Charles, IL (US); Sai Swetha Gujja, Naperville, IL (US); Howard Israel Nayberg, Plainview, NY (US); Janet Pauline Eva Lowry, Addison, IL (US); Dean C. Harrington, Oswego, IL (US); Jammie Lee Pringle, Romeoville, IL (US); Patrick Nicholas Medved, Plainfield, IL (US); Sainaga Kishore Srikantham, Aurora, IL (US)

(21) Appl. No.: 15/224,392

(22) Filed: Jul. 29, 2016

(51) Int. Cl. G06F 9/455; G06F 9/48

(52) U.S. Cl. CPC G06F 9/45516; G06F 9/4881

(57) ABSTRACT

A JVM can be used for secure and efficient processing of work items from different processors for a mainframe environment. The JVM provides the infrastructure that allows a hierarchy of Java programs to run within the JVM to efficiently manage work items placed within the JVM address space. A work item router invokes native program code with the Java Native Interface (JNI) to begin monitoring the JVM address space for work items. When a work item is passed to the work item router via the JNI, the work item router routes the work item to a corresponding one of a set of class-based work managers. Each of the class-based work managers manages a class of work. When a class-based work manager obtains a work item result, the class-based work manager invokes the native program code via the JNI to return the result to an originating address space.

### BACKGROUND

The disclosure generally relates to the field of data processing, and more particularly to cross communication between address spaces.

Mainframe operating systems typically use address spaces as a structuring tool to help in isolating failures and to provide for reliability, stability, availability, and security. An address space is a range of virtual addresses that an operating system assigns to a user or program for executing instructions and storing data. The range of virtual addresses maps to physical memory, either directly or via another level of indirection. Mainframe operating systems also manage mapping of virtual addresses to a common storage of the mainframe. A mainframe uses common storage to allow processes to transfer data instantiated as objects in common storage.

### BRIEF DESCRIPTION OF THE DRAWINGS

Embodiments of the disclosure may be better understood by referencing the accompanying drawings.

FIG. 1 depicts a conceptual example of work items being offloaded to a JVM address space from other address spaces in a mainframe environment.

FIG. 2 depicts a flow diagram of example operations for a Java based offloading service in a mainframe environment for multiple classes of work items.

FIG. 3 depicts a flow diagram of example operations for dispatching and processing work items by a Java-based offload service provider in a mainframe environment.

FIG. 4 depicts a flow diagram of example operations for processing and returning a result of a processed work item by a Java-based offload service provider in a mainframe environment.

FIG. 5 depicts an example mainframe with a Multi-Class Work Item Java based offload service provider.

### DESCRIPTION

The description that follows includes example systems, methods, techniques, and program flows that embody embodiments of the disclosure. However, it is understood that this disclosure may be practiced without these specific details. For instance, this disclosure refers to cross-address space communications with a Java Process in a Java Virtual Machine (JVM) residing in an address space in illustrative examples. But aspects of this disclosure can be applied to cross-address space communications with any application or process in a virtual machine (e.g., common language runtime) residing in an address space. Aspects of this disclosure can also be applied to other programming frameworks, such as Raw Native Interface (RNI), that enable a process inside a virtual machine to communicate with other program/platform dependent languages. In other instances, well-known instruction instances, protocols, structures, and techniques have not been shown in detail in order not to obfuscate the description.

### Introduction

A computing task or group of computing tasks (“work item”) can be offloaded to a specialized resource within a mainframe environment. A work item may be data and/or program code. Offloading a work item involves a transfer of the work item from an address space of a requesting process on the mainframe to an address space corresponding to a trusted resource on the mainframe. Using the trusted resource leverages the capability of the mainframe for concurrent secure processing of transactions on a large scale (e.g., hundreds of thousands of transactions per second).

### Overview

A JVM can be used for secure and efficient processing of work items from different processes for a mainframe environment. The JVM provides the infrastructure that allows a hierarchy of Java programs to run within the JVM to efficiently manage work items placed within the JVM address space. Although work items on a mainframe can be passed between address spaces through common storage, this may raise security concerns since both authorized and unauthorized programs can read common storage. A Java program that routes work items (“work item router”) invokes native program code with the Java Native Interface (JNI) to begin monitoring the JVM address space for work items. When a work item is passed to the work item router via the JNI, the work item router routes the work item to a corresponding one of a set of class-based work managers. Each of the class-based work managers manages a class of work (e.g., encryption work, protocol specific work, etc.). When a class-based work manager obtains a work item result, the class-based work manager invokes the native program code via the JNI. The invoked native program code writes the work item result in a designated area of the JVM's address space to be retrieved and written to an originating address space.

### Example Illustrations

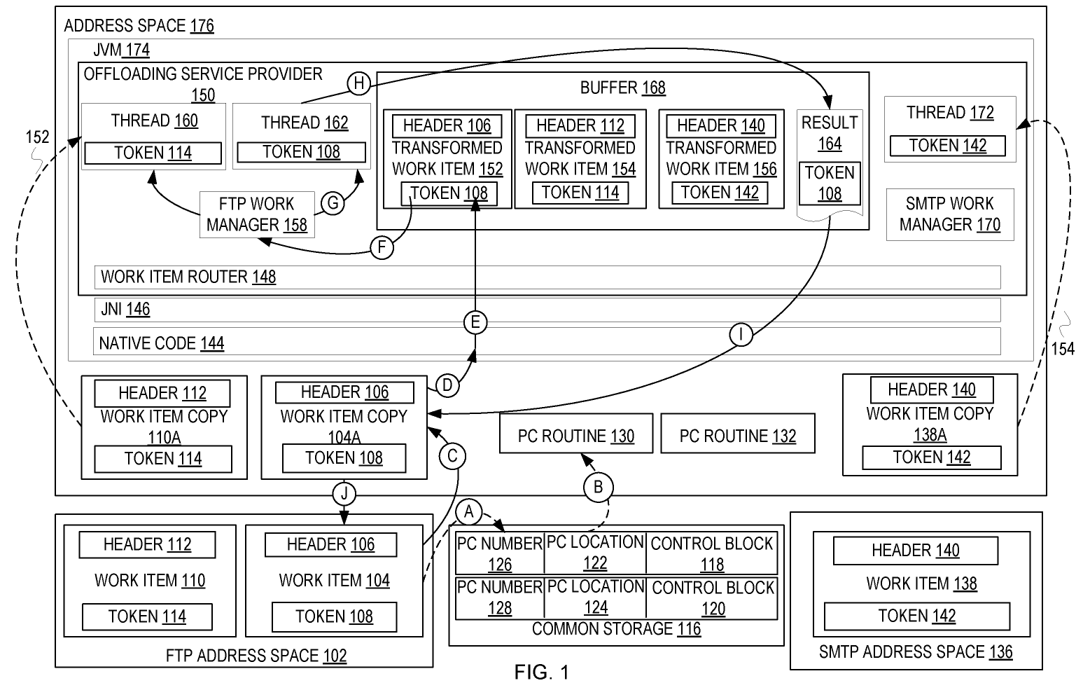

FIG. 1 depicts a conceptual example of work items being offloaded to a JVM address space from other address spaces in a mainframe environment. FIG. 1 includes service requestors within a file transfer protocol (FTP) address space 102 and in a simple mail transfer protocol (SMTP) address space 136. These service requestors are in communication with an offloading service provider (“service provider”) 150 that resides within a JVM address space 176. The service requestors and the service provider 150 have already established trust between each other. The service requestors and the service provider 150 may all be hosted on one mainframe. An FTP server process is running in the FTP address space 102. An SMTP server process is running in the SMTP address space 136. The service provider 150 is running in a JVM 174 of the address space 176. The address space 176 also hosts space-switching program call (PC) routines 130 and 132. The JVM 174 encapsulates the service provider 150, a JNI 146 and a native program code (hereinafter “native code”) 144. The service provider 150 encapsulates a work item router 148, an FTP work manager 158, and an SMTP work manager 170. The JNI 146 can be considered to encapsulate the native code 144 in some cases.

FIG. 1 is annotated with a series of letters A to K. Each of these letters represents stages of one or more operations. Although these stages are ordered for this example, the stages illustrate one example to aid in understanding this disclosure and should not be used to limit the claims. Subject matter falling within the scope of the claims can vary with respect to the order and some of the operations.

The service provider 150 depicted in FIG. 1 can handle multiple work items simultaneously by leveraging a hierarchy of programs. The hierarchy of work programs consists of a work item router 148 and at least one class-based work manager. In this example, the work item router 148 routes to two class-based work managers: an FTP work manager 158 and an SMTP work manager 170. Each work manager can be considered to manage a class of work items. A class of work items may relate to a specific type of processing (e.g., encryption), a particular application program, a specific protocol or standard, etc. The work item router 148 routes FTP related work items to the FTP work manager 158 and SMTP related work items to the SMTP work manager 170. The work managers 158, 170, in turn, assign each work item received to a thread for processing.

An FTP process is used to transfer files between devices. Before sending the files, the files are first sent to the service provider 150 for pre-processing (e.g., detecting and classifying sensitive data). The service provider 150 is a Java process running in the JVM 174 that can route files to a class-based work manager for analysis. For example, the service provider 150 may route a file to an FTP work manager that analyzes the file for sensitive data and mask or mark that sensitive data.

When the service provider 150 starts, the service provider 150 initializes the infrastructure of the address space 176 for cross address space processing of work items. The service provider 150 registers with the operating system of the mainframe environment. This registration includes creating an anchor in a common storage 116 (e.g., an anchor control block) and/or the address space 176. The anchor in the common storage 116 is a root for work items to be processed by the service provider 150. The anchor may contain information such as a PC routine number, PC location, and status of a PC routine. The location of the anchor is available for discovery by other processes like the service requestors: the FTP process and the SMTP process. The service provider 150 generates the PC routine 130 and stores a pointer to the PC routine 130 in a control block 118. The pointer is a PC number 126 and a PC location 122. In addition, the anchor may also contain information regarding the PC routine 130 authorizations and the runtime environment for the PC routine 130. This setup may include establishing a contract or specification that defines a format or arrangement of a work item 104 such as the parameters to be passed to the PC routine 130. The contract or specification may also include the format and information for work items to be offloaded. For instance, the anchor may specify expected format and information in a header 106 of the work item 104. The information includes information used by the work item router 148 to route the work item 104, such as specifying FTP and/or the particular work manager to handle the work item 104 (i.e. the FTP work manager 158). In addition, the service provider 150 obtains authority and/or privileges for the PC routine 130 to access the FTP address space 102, and the address space 176. For example, in order to move data between address spaces, an authority to use the instruction “set secondary address register” (SSAR) may be set. The service provider 150 carries out this registration with calls to the operating system using the native methods in the native code 144 via the JNI 146.

After establishing the anchor in common storage 116 and obtaining authority and/or privileges for the PC routine 130, the PC routine 130 is in a ready or an active status. The ready or active status means that the PC routine 130 is available to be called. In addition, the service provider 150 invokes a native method of the native code 144 through the JNI 146 to begin monitoring for work items in the address space 176. The invoked native method, for example, can be a Multiple Virtual Storage (MVS) WAIT macro.

Prior to stage A, the FTP process in the FTP address space 102 generates the work item 104 in the FTP address space 102. As stated earlier, the work item 104 can be data to be processed or program code to be executed. The work item 104 may contain a token 108 that contains the identifier for the work item 104. The FTP process may use a different means of identifying the work item 104 other than a token. For example, the FTP process may use a globally unique identifier (GUID), timestamp, or a unique identifier from a monotonically increasing counter maintained by the FTP process. The work item 104 also contains the header 106 that contains information for use when processing the work item 104 (e.g., the FTP work manager 158 identifier). The header 106 may be divided into 2 sections. The first section is common to all work items. The second section contains information regarding the originating address space and/or the class the work item belongs to. The work item 104 may also contain information such as the PC number 126, instruction address or the PC location 122 of the PC routine 130. In another example, this information may be contained as a value and/or parameter of a method or function of the FTP process. A PC routine is a group of related instructions. If the PC routine is space switching, it allows easy access to data in both a primary (i.e. the service provider's address space) and a secondary address space (i.e. the service requestor's address space).

At stage A, the FTP process issues a PC instruction to call the PC routine 130. The PC instruction contains identifying information of the work item 104 (e.g., the token 108) and the PC number 126 of the PC routine 130. The PC number 126 identifies which PC routine to invoke. Once identified, at stage B, the PC location 122 is used to identify the location of the PC routine 130 in the address space 176. Control of the work item 104 is then passed to the PC routine 130.

At stage C, once control of the work item 104 is passed to the PC routine 130, the PC routine 130 validates the work item 104 and makes a copy of the work item 104 (“work item copy 104A”) in the address space 176. Copying to the address space 176 can be considered synonymous to copying to the JVM 174. Copying may be performed by using an assembler instruction such as “move character to primary” (MVCP). MVCP calls move data from the secondary address space to the primary address space. The primary address space hosts the program that will process the request. The operating system of the service provider 150 may place constraints (e.g., to conform to execution privileges) on what can be written into the address space 176 and/or where it can be written into the address space 176.

Since each address space may have its own set of security and/or access rules and can disallow other processes, copying work items from one address space to another address space instead of using the common storage may provide better security and/or data integrity. This is in contrast to common storage access which is accessible to any mainframe process. For example, the work items may be copied to the private area of the service provider's address space, thus may only allow access to processes and/or routines authorized by the service provider.

At stage D, the copying of the work item 104 to the address space 176 causes generation of a notification. To generate the notification, the PC routine 130 can issue an MVS POST (“POST”). The POST macro is used to notify processes about the completion of an event, which in this case was the creation of the work item copy 104A in the address space 176. Issuance of the POST causes the native method previously invoked by the Java process to “wake up” (i.e., continue execution) and read the work item copy 104A in the address space 176. For instance, an MVS dispatcher (“system dispatcher”) can update an event control block (ECB) to reflect the write of the work item copy 104A into the address space 176. This ECB update causes the native method of the native code 144 to resume execution. The PC routine then issues an MVS WAIT (“WAIT”) to begin monitoring for the work item result.

At stage E, the service provider 150 obtains access to the work item copy 104A from the resumed execution of the native code 144. Execution of the native code 144 causes the work item copy 104A to be written into a buffer 168 of the JVM 174, after a possible transformation. The native code 144 includes a native method that transforms the work item copy 104A according to a specification that identifies data type conversions and format encodings for data moving between Java methods and native methods. The native code 144 transforms the work item 104 into a form that can be consumed by the service provider 150 and writes a transformed work item 152 into the buffer 168 (e.g., a char buffer). In addition to the transformed work item 152, the executing the native code 144 also passes the token 108 and the header 106. The token 108 facilitates the return of a result for the work item 104 to the FTP address space 102. The header 106 allows the identification of the class of the work item 104. The token 108 and the header 106 can be associated with the work item 104 and/or the transformed work item 152. The passing of the work item 104 may include the passing of the token 108 and the header 106 which are embedded within the work item 104. In other embodiments, the token 108 and the header 106 are not embedded and may be communicated via transfer control information read by the executing the native code 144 from transfer control structures of the service provider 150. The token 108 for the work item 104 may be the address within the FTP address space 102 of the work item 104 and/or an identifier of the FTP process.

At stage F, the writing of the transformed work item 152 to the buffer 168 may cause a notification to be generated that allows the work item router 148 to detect the transformed work item 152 and assign it to the FTP work manager 158. To generate the notification, the service provider can have a Java method, for example a method named “Post,” that issues a notification when invoked by the posting of a work item in the Java buffer. The notification may include an identifier of the work item posted, such as a reference to the work item token. Issuance of a notification by the invoked Post method causes the work item router 148 to read the transformed work item 152 from the buffer 168. The work item router 148 examines the header 106 of the transformed work item 152 to identify the appropriate class-based work manager. The header 106 contains an identifier of the FTP work manager 158. In addition, the work item router 148 examines the header 106 to determine if the transformed work item 152 conforms to a defined structure.

At stage G, the FTP work manager 158 assigns the transformed work item 152 to a thread 162. In addition, the FTP work manager passes the token 108 to the thread 162. The thread 162 may come from a thread pool. The thread pool represents one or more threads available for task assignment. The size of the thread pool may be automatically adjusted depending on the number of work items to be processed. When a work item is submitted and there are no more available threads in the thread pool, a new thread may be generated. The assignment of a work item to a thread may be implemented by using the classes in the Java Executor and ExecutorService interfaces for example.

At stage H, the thread 162 finishes processing and/or performing the transformed work item 152 and writes a response containing a work item result (hereinafter “result”) 164 to the buffer 168. The result 164 also contains the token 108 that facilitates the return of the result 164 to the work item 104. The result 164 may be an object or any other format (e.g., string, bit flag, etc.) or combination thereof. In some scenarios, a response may contain further instructions, or a status (e.g., OK, completed) and/or any other information (e.g., reason for status). With tracking information (e.g., a thread identifier, a session identifier, etc.) the FTP work manager 158 can determine a thread that corresponds to a work item that is being processed.

At stage I, the writing of the result 164 to the buffer 168 causes a notification to be generated that allows the service provider 150 to invoke another native method of the native code 144 via the JNI 146 to transform result 164 for updating of the copy of the work item 104. The code implementation underlying the PUT-type method reads the result 164 from the buffer 168 and transforms the result 164 into a form (e.g., format and/or encoding) compatible with the FTP process.

The invoked native method of the native code 144 performs a write operation to update the work item copy 104A as specified by the FTP process. For instance, the FTP process could have created the work item 104 with a layout that accommodates the (transformed) result 164 (e.g., created an object larger than the data to be processed or with a field(s) reserved for the result). The (transformed) result 164 is written at a particular location within the work item copy 104A. The native code 144 then issues a POST macro that causes the PC routine 130 to resume the processing of the work item copy 104A. Upon resumption of the processing, control of the work item copy 104A is transferred to the PC routine 130.

At stage J, the invoked native method of the native code 144 invokes the PC routine 130 to update the work item 104 in the FTP address space 102 with the updated copy of the work item 104 by issuing a POST macro as stated earlier. Issuance of the POST macro causes the PC routine 130 previously invoked by the service requestor to “wake up” (i.e., continue execution). The PC routine 130 locates the work item 104 in the FTP address space 102 with the use of the token 108. The PC routine 130 may also use a POST macro which causes an update of the work item 104. In another example, the PC routine 130 may use the POST to cause the (transformed) result 164 from the work item copy 104A to be written at a particular location within the work item 104. In yet another example, the PC routine 130 may overwrite the work item 104 with the updated work item copy 104A from the address space 176. After the update, control of the work item 104 is passed from the PC routine 130 back to the FTP process in the FTP address space 102.

The discussion has focused on the processing path of a single work item through the offloading service for ease of understanding. The offload service, however, is designed to handle multiple work items in the same class and across different classes. Thus, FIG. 1 also depicts a work item 110 from the FTP address space 102 and a work item 138 from the SMTP address space 136. These work items 110, 138 traverse a similar operational path as described in stages A-E. A dashed line 152 represents the logical flow of a copy 110A of the work item 110 to a thread 160. A dashed line 154 represents the logical flow of a copy 138A of the work item 138. The work item 110 was copied into the address space 176 by the invoked PC routine 130, resulting in the work item copy 110A. The PC routine 130 was invoked by a PC instruction, issued by the FTP process, containing the PC number 126 which is associated with the PC location 122 in the control block 118. The work item copy 110A was written to the buffer 168 of the JVM 174 by the native method of the native code 144 via the JNI 146, after a transformation into a transformed work item 154. The work item router 148 examines a header 112 of the transformed work item 154 and routes the transformed work item 154 to the FTP work manager 158 for processing. A token 114 may be used to keep track of the work item copy 110A as versions of the work item 110 travel across the address space 176, the buffer 168, and the FTP work manager 158 and preserve association with the offloaded work item 110. The FTP work manager 158 assigns the transformed work item 154 to the thread 160 dispatched by the FTP work manager 158. The thread 160 may be dispatched simultaneously with the thread 162.

For the work item 138, the invoked PC routine 132 copied the work item 138 into the address space 176, resulting in the work item copy 138A. The PC routine 132 was invoked by a PC instruction containing a PC number 128 which is associated with a PC location 124 in a control block 120. Because the control block 120 is located in the common storage 116 it is discoverable by the SMTP process. The native method of the native code 144 wrote the work item copy 138A to the buffer 168 of the JVM 174 via the JNI 146, after a transformation into a transformed work item 156. The work item router 148 examines a header 140 of the transformed work item 156 and routes the transformed work item 156 to the SMTP work manager 170 for processing. A token 142 was used to keep track of versions of the work item 138 across the address space 176, the buffer 168, and the SMTP work manager 170.

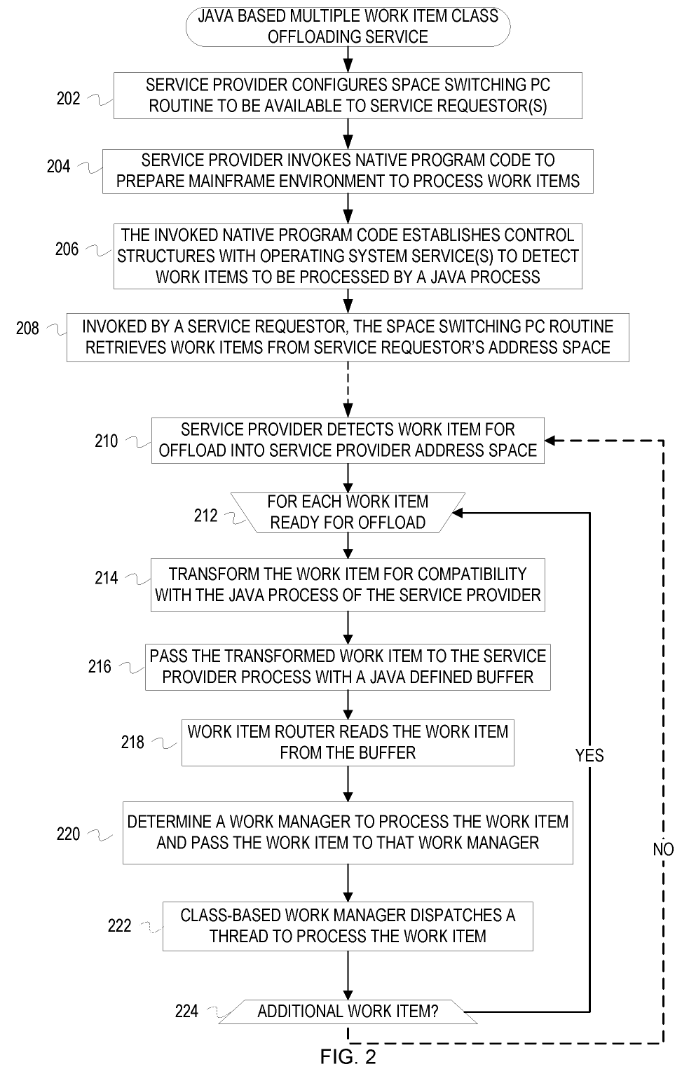

FIG. 2 depicts a flow diagram of example operations for a Java based offloading service in a mainframe environment for multiple classes of work items. FIG. 2 refers to a service as performing the example operations for consistency with FIG. 1 and not to constrain claims, implementations, or interpretations. The term “mainframe environment” is used to collectively refer to an operating system of a mainframe and associated hardware components. FIG. 2 depicts operations to establish the infrastructure for the multi-class work item offloading service in a mainframe environment and processing of offloaded work items within and across classes. FIG. 2 uses dashed lines to depict asynchronous flow. For example, a waiting state or transition state corresponding to an asynchronous request-response exchange.

A service provider configures a space switching PC routine to be available for invocation by an authorized service requestor(s) (202). The PC routine gets control of the work item upon invocation. The PC routine returns control to the invoking process after processing by the service provider. To make a PC routine available to service requestors, the service provider may use operating system macros such as the ATSET which sets the authorization table; and/or the AXSET which sets authorization index. A service requestor is a program that may use the service provider to process work items. The service requestor invokes the PC routine by issuing a PC instruction. The service provider also sets the level of authority of the service requestors and/or performs functions to enable the service requestors to invoke the PC routine. For example, the service provider updates the PSW-key mask (PKM) value in the service requestor to include the ability to run the PC routine. The PC routine can be invoked with executable macro instructions. The invoking program keeps track of this invocation in control blocks. The control blocks serve as communication tools in the mainframe environment. For example, a control block has the identifier, location, and status of the PC routines.

The service provider invokes the native program code to prepare the mainframe environment to process work items (204). The service provider invokes the native program code through a JNI to establish information and structures in the mainframe environment for detecting the posting of work items for processing by the Java-based processing service (206). Establishing the information and structures can be considered a registration process carried out with defined operating system (OS) calls, which cause a service of the OS to notify the Java-based processing service of posted work items. For example, a Java program for the service provider can be written with a Java method named “Start” that maps to native program code that implements the Start Java method with native methods defined for the mainframe environment. After the invoked native methods implementing the Java Start complete, the service provider is ready for processing of work items from other address spaces. The service provider then invokes a Java defined Get that the JNI maps to native methods that include a GET and WAIT. The native program code will invoke the GET method to read structured data (e.g., a work item) from a specified location, in this case, a location in the address space allocated for work items. The native program code will also invoke the WAIT method since work items may not yet be posted to the location in the address space. Prior to the GET and WAIT, the native implementation of the Java Start method will establish an offloading anchor in the address space. The offloading anchor can be considered a front of a queue or list to host work items to be retrieved by the Java-based processing service. Creation of this offloading anchor involves the native program code making OS defined calls that initialize an area of the address space to associate it with the service provider (e.g., create a task storage anchor block) and create a control block that allows a requesting process to pass control of a copied work item to the processing service and/or causes an OS service to resume execution of the native program code (“wake-up” the native program code). When multiple work items are pending in the list, the list can be traversed starting at the offloading anchor to retrieve the pending work items.

When invoked, the PC routine retrieves the work item from the invoking service requestor's address space (208). The work item includes a token and a header used for processing of the work item. In addition, the PC routine may retrieve other information that may be utilized to process the work item such as parameter values and/or timeout settings. To “retrieve” the work item, the native program code copies the work item into the service provider address space, which is the address space assigned to the Java-based service provider by the mainframe environment. The PC routine may also keep track of the current status and/or location of the work item. After the PC routine retrieves the work item, the PC routine issues a WAIT macro. The work item will remain in the wait condition until after the PC routine detects a POST.

The service provider detects copying of a work item for offload into the service provider address space with the established information and structures (210). When a work item is copied into the address space associated with the service provider, the OS service wakes-up the native program code of the service provider. The OS service may update a control block associated with the service provider. The OS service may update the control block with information that identifies the work item (e.g., token associated with the work item) and/or a process that generated the work item (e.g., by process identifier). Since multiple work items may have been copied while the native program code was in a wait state or while processing another work item, the native program code of the service provider may traverse the address space storage area from the anchor to process each work item ready for processing (212). The native program code of the offload service may use an ECBLIST to monitor for copied work items. Each event control block (ECB) in the ECBLIST can represent a pending work item. When the native program code retrieves a work item, the native program code decrements the ECBLIST counter. The native program code of the offload service will continue retrieving work items represented by the ECBs until the ECBLIST counter reaches 0.

Upon detection of a pending work item, the native program process (executing native program code) transforms the work item to be compatible with the Java process of the service provider (214). The transformation may include altering the work item to an encoding and/or format compatible with the Java process of the service provider. After transformation of the work item, the native program code passes the transformed work item to the service provider with a Java defined buffer (e.g., char buffer) (216). To “pass” the transformed work item, the native program code invokes a native method that maps to a Java method that notifies the service provider of a pending item in the buffer. The JNI may rearrange arguments of the native method to conform to the semantics of the Java method. The arguments can include a memory address that corresponds to the Java buffer. The JNI may define the earlier GET method to establish a memory address that corresponds to the Java buffer for the passing of the work item. From the perspective of the native program code, the transformed work item is copied to an address space that may be without any awareness of it supporting a Java buffer (216). The address has previously been associated with the Java buffer by the JVM.

Once notified of the work item in the Java buffer, the service provider invokes the work item router to read the work item from the buffer (218). The work item router then routes the work item to the appropriate work manager for processing (220). The work item router may have several class-based work managers that the work item router can assign the work items to. Each of the work managers can process a certain class or type of work item. For example, an FTP work manager can process FTP work items and an SMTP work manager can process SMTP work items. This information is placed by the service requestor in a header of the work item. The work item router examines the header or metadata of the work item to determine the type or class of work item, which corresponds to the work manager that should process the work item. This examination includes determining if the work item conforms to a defined structure previously identified to the service provider. For example, the header may contain the identifier of the work manager that should process the work item. In addition, the token associated with the work item is obtained and passed to the work manager and is used to find the appropriate work item to send the results to when processing is done. As another example, metadata in a header of the work item may identify a work item class or work item type that the work item routers uses to route the work item. The metadata that indicates work item class/type conforms to a classification/typing established standards

In other embodiments, work items can resolve to work managers by privilege level associated with the service requestor or an originator of the work item and/or by type/category of the work item either defined in the work item or determined by the service provider. For instance, the service provider can communicate a type of work item to a particular work manager via the work item router depending on the originator.

Once the work manager receives the work item for processing, the work manager dispatches a thread to process the work item (222). A thread is a running instance of code that processes the work item. For example, if the work item is a program code to be executed, then the thread executes the code. In another example, the work item may be a data file to be analyzed for sensitive information, then the thread analyzes the data contained in the data file and performs the necessary operation (e.g., marking or masking the sensitive information) and/or sends a response such as a flag on whether to allow the transmission of the data file. The thread also has access to the token associated with the work item. As mentioned earlier, the token is used to find the appropriate work item to send the results to when processing is done.

If there is an additional transformed work item in the buffer (224), then the service provider will process the next work item (212). If there is no additional transformed work item in the buffer, the native program code will continue monitoring and retrieving posted work items (210).

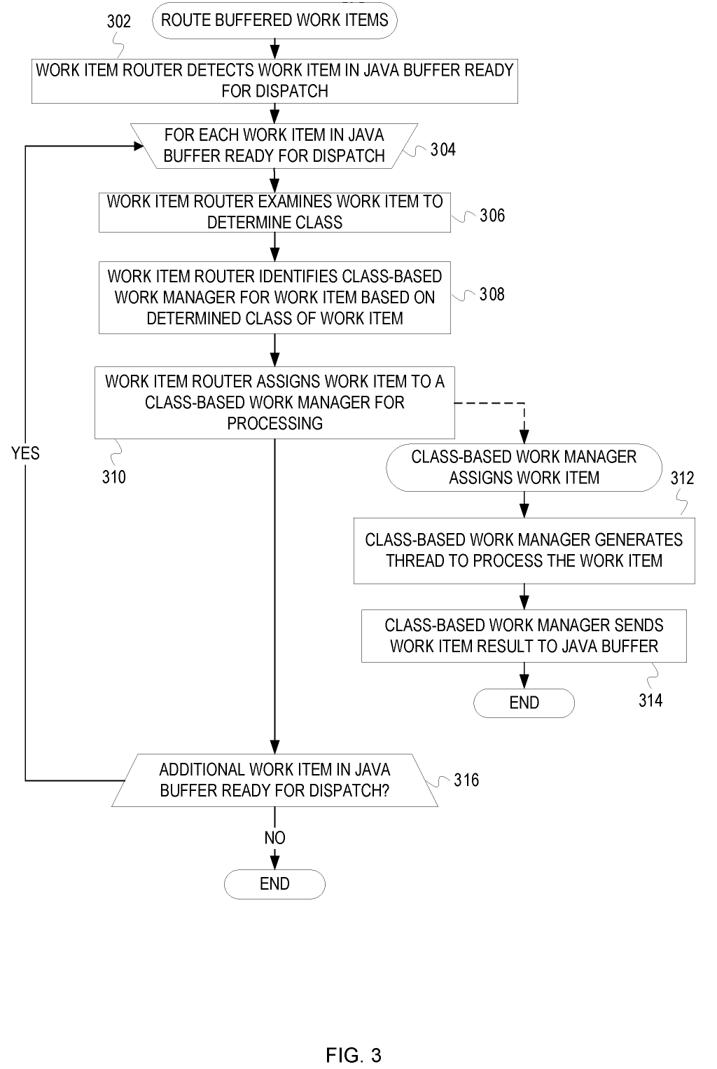

FIG. 3 depicts a flow diagram of example operations for a work item router to route work items to work managers. As previously discussed, the work items being routed may be a version of the work item copied into the Java-based offloading service provider address from a service requestor address space. FIG. 3 uses dashed lines to depict the transfer of the work to a different program performing a task in the flow diagram. For example, the work item router may perform the tasks in the flow diagram until the work item router passes the work item to the class-based work manager at which point the diagram depicts the actions of a class-based work manager.

A work item router of the service provider in a JVM in a mainframe environment detects a work item in the Java-defined buffer (302). The work item router can monitor the buffer for work items posted by the native program code via the JNI. The detection of a work item can be triggered by the POST command of the native program code. In another example, the work item router receives a notification such as a message from a Java method that gets invoked after the work item was posted in the buffer. The message can include the token that identifies the posted work item.

Upon detection of a work item, the work item router examines each work item in the buffer (304). The buffer may have several work items in the buffer since several work items can be posted while the work item router is routing a work item. The work item router may examine each work item to determine the work item's class or type to determine the class-based work manager to be used to process the work item (306). The work item may include information that identifies the class or type of processing such as a header that may contain an identifier, a field, or a metadata. The identifier may be a globally unique identifier (GUID) that may be established and maintained by the service provider. The GUID may be mapped or associated with a class or type of the work item. The field may be a string that identifies a protocol that may be used in processing the work item. The metadata may include access information to connect to an FTP server to access data for example.

Based, at least in part on the identifier used to determine the class of the work item, the work item router identifies the class-based work manager to process the work item (308). The work item router uses the identifier to determine the class-based work manager that is associated with the work item class or type. The association may be represented in a table that maps the identifier to the work manager for example. In another example, the class identifier may be a uniform resource identifier (URI) that may be used to resolve to the work manager. In yet another example, the header contains an identifier that identifies the work manager (e.g., the FTP work manager identifier) that will process the work item.

Once the class-based work manager is identified, the work item router assigns the work item to the class-based work manager (310). The work item router may use the identifier of the class-based work manager as a parameter to a method that assigns the class-based work manager to the work item. In another example, the work item router adds the work item to a queue that is monitored by the class-based work manager for work items to be processed.

The class-based work manager is a program that can concurrently process several work items at the same time by using threads for example. When the class-based work manager is notified that a work item is assigned to it, the class-based work manager generates a thread to process the work item (312). A thread is a sequence of program instructions that executes the work item. The Java Thread class may be used to generate a thread, for example. Another way to create a thread is by implementing the Java Runnable interface. After the thread is generated, the thread goes into the runnable state. The thread is in the runnable state when it is processing a task. If a work item gets assigned to the class-based work manager before it finishes creating a thread to process a work item that was assigned earlier, the class-based work manager may put the pending work item in a queue.

Class-based work managers process work items by class or type. For example, FTP work items are processed by an FTP work manager while SMTP work items are processed by an SMTP work manager. Other class-based work managers may be configured to process other classes of work items (e.g., an encryption work manager, a key generator work manager, etc.).

The class-based work manager keeps track of the thread using a thread identifier and associates the thread identifier with the work item token. The thread identifier may be a GUID or time-based identifiers such as a timestamp or unique identifier from a monotonically increasing counter maintained by the class-based work manager. When the work item is complete, the thread exits or terminates. The class-based work manager may also maintain a timeout (e.g., no result after a set time period) to either terminate or retry processing the work item. The timeout may be configurable by the class-based work manager, the service provider and/or an administrator.

Once the thread terminates, the class-based work manager sends the work item result to the Java buffer (314). The class-based work manager may use the Java buffered I/O streams to write the work item result to the buffer. The class-based work manager may write into the buffer using the buffer's PUT method. The class-based work manager may write the work item result into a specific position in the buffer. As mentioned earlier, the work item result contains a token to facilitate the return of the result of the work item to the service requestor. The writing of the work item result into the buffer may create a notification signal to the native code that a result is available for the work item.

If there is an additional work item in the buffer ready for dispatch (316), then the class-based work manager will route the next work item (304).

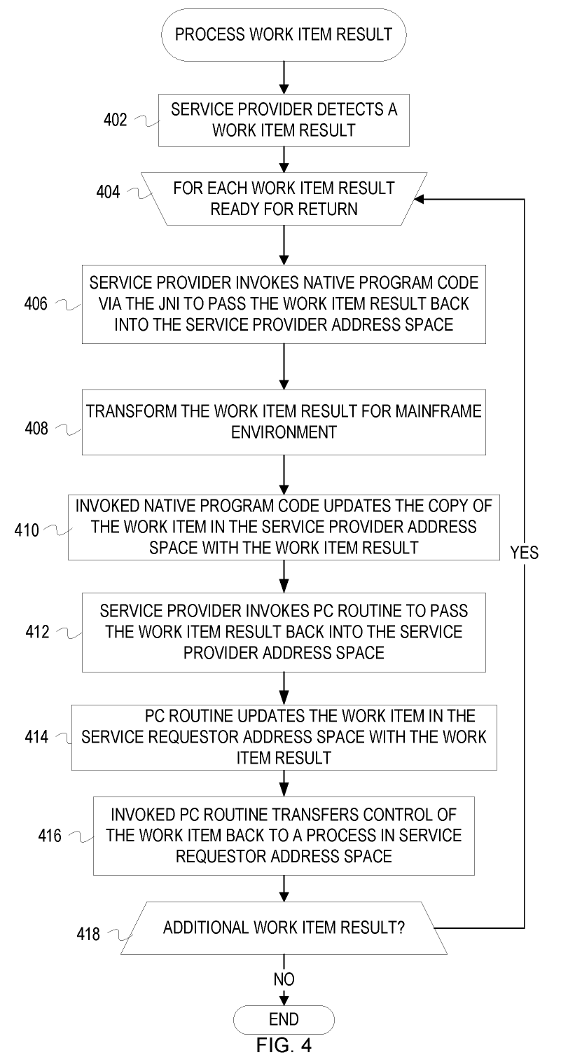

FIG. 4 depicts a flow diagram of example operations for processing and returning a result of a processed work item by a Java-based offload service provider in a mainframe environment. Previously, the offload service provider has processed the work items with the service provider's class-based work manager(s).

The service provider in a JVM in a mainframe environment detects a work item result (402). The service provider can monitor a buffer or queue for responses from offload resources (“result buffer”). Detection of a work item result can be triggered based on receipt of a message according to a network communication protocol. The service provider may keep track of the work items by assigning a unique Job Identifier with each work item the service provider offloads. If a response is not received within a specific time period, the service provider may resend the work request. The service provider is not blocked by waiting for a response for a particular Job Identifier, the service provider may continue processing other work items requests or previously detected work item results.

Upon detection of a work item result, the service provider begins processing each work item result in the result buffer (404). The result buffer may host multiple work item results since multiple work items can be received concurrently and/or can be received while the service provider (or thread of the service provider) is in a wait state. A work item result being processed is referred to as a “selected result.” With tracking information (e.g., job identifier, a session identifier, etc.) the service provider can determine a previously retrieved work item that corresponds to the selected result.

The service provider invokes native program code via a JNI to pass the selected result back into the Java address space (406). For example, the service provider invokes a Java method, Put, that the JNI translates or maps to native program code that includes a native PUT method. Because the service provider cannot directly access low-level resources like the Java address space, the service provider leverages the native program code presented via the JNI to invoke the native program code to write the work item result to the Java address space. The JNI includes program code that extracts the arguments from the Java Put method to conform to the semantics of a native PUT method of the native program code mapped to the Java Put method. In addition, the JNI includes program code that transforms the selected result for compatibility with native formatting/encoding (408).

After transformation of the selected result, the invoked native program code updates the copy of the work item in the Java address space with the transformed, selected result (410). For instance, the native program code updates particular locations (e.g., fields) of the copy of the work item with the transformed, selected result. The layout of the work item may have been previously communicated with the work item. As another example, the selected result may comprise of the work item already updated with the work item result by the service provider. Thus, updating the copy of the work item in the Java address space may be overwriting the copy of the work item in Java address space with an already updated work item. In some cases, the work item will have specified a location for the work item result other than where the work item resides. The native program code can write a work item result to the specified location in the Java address space.

After placing the transformed, selected result into the Java address space, the native program code issues a POST macro. A POST macro is issued to signal the completion of the processing of the work item, which synchronizes with the WAIT macro that was issued by the PC routine after it copied the work item for processing to the Java address space. The PC routine detects the issuance of the POST macro and resumes processing of the work item by passing the work item copy back to the originating address space (i.e. the address space of the process that requested the corresponding work item) (412). The issuance of the POST macro gives control of the work item to the PC routine. The location of the PC routine is identified by the PC location that is associated with the PC number. The PC number and PC location association may be in a table entry form in a control block in the common storage. The control block may have been created and/or initialized when the service provider started.

The invoked PC routine updates particular fields of the work item with the transformed, selected result (414) similar to block 410. In another instance, the PC routine overwrites the work item in the originating address space. After placing the transformed, selected result into the originating address space, the PC routine passes control of the work item to the originating process (i.e. the process that requested the corresponding work item from the non-Java address space) (416). The transfer control mechanisms and/or inter-process request mechanisms of the mainframe operating system create objects (e.g., transfer control blocks or service request blocks) or maintain data that indicate work requests waiting to be completed. For example, the PC routine may also update the ECB to indicate that that the work item is complete. With the indication that the work item is complete in the ECB, control returns to the originating process. As another example, the native program code of the offload service may issue a TRANSFER command. After or while the PC routine of the offload service provides the work item result, the service provider continues processing additionally detected work item results if any (418).

### Variations

The above example illustrations presume that the offloading process is programmed to offload particular work items to the Java-based service provider. However, a mainframe service, for example, a dispatch service, can evaluate and determine whether a work item should be directed to the Java-based service provider or to a resource outside of the mainframe.

The above example illustrations refer to transformations of work items and transformations of arguments between Java methods and native methods. One example refers to the native program code performing a transformation. The transformations can be performed either by the native program code or by Java program code. Transformations may be performed by both types of program code depending upon the direction of the transformation. For example, the native program code encapsulated within or referenced by the transforming interface can include native program code to perform transformations of work items being offloaded to the Java-based offload service. When a work item result is returned, Java program code of the transforming interface can transform the work item result.

The above example illustrations refer to assigning a work item and generating a thread to process the work item. In other embodiments, instead of generating the thread to process the work item, the dispatched thread may be part of an existing thread pool. A thread pool represents one or more threads waiting for work to be assigned to them. When the number of threads in the pool reaches a certain threshold or if there is no available thread in the pool, the work manager can generate more threads and add it to the pool. Once the processing is completed, the thread is returned to the pool to wait for a new assignment instead of being terminated. In yet another example, the work item may be processed by several threads instead of one. A work item may be subdivided by the work manager and dispatched to more than one thread. The work manager may also take as an argument the number of threads to generate in processing a work item. The results of each thread will be synchronized by the work manager prior to posting in the Java buffer. The work manager may also have several thread pools available for dispatch. In yet another example, the service provider may be configured to control the performance of the work managers. For example, a limit on the number of threads that can be dispatched may be set.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel, and the operations may be performed in a different order. For example, the operations depicted in blocks 202 and 206 can be performed in parallel or concurrently. With respect to FIG. 4, an update of the copy of the work item in the address space is not necessary. The update may be done directly on the work item from the originating process. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of the platform (operating system and/or hardware), application ecosystem, interfaces, programmer preferences, programming language, administrator preferences, etc.

Any combination of one or more machine readable medium(s) may be utilized. The machine-readable medium may be a machine readable signal medium or a machine-readable storage medium. A machine readable storage medium may be, for example, but not limited to, a system, apparatus, or device, that employs any one of or a combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object-oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

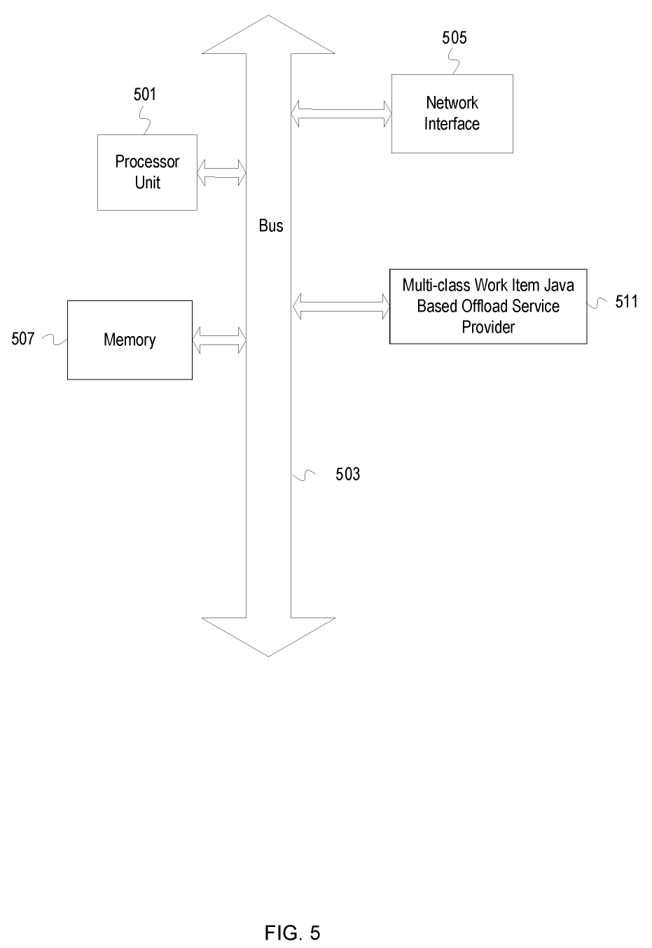

FIG. 5 depicts an example mainframe with a Multi-Class Work Item Java based offload service provider. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The mainframe also includes Java-based offload service provider 511 for various classes of work items. The Java-based offload service provider 511 processes work items of various types/classes from a non-Java address space on the mainframe. Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for Java-based processing of cross address space work items as described herein may be implemented with facilities consistent with any hardware system or hardware systems. Many variations, modifications, additions and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
an invoked space switching program call routine copying a computing task from a first address space to a second address space in a mainframe environment, wherein a Java virtual machine (JVM) executes within the second address space;
in response to detection of the computing task in the second address space, a native process of the second address space sending, via a native program code interface, the computing task to a task routing process in the JVM;
in response to detection of the computing task from the native process, the task routing process determining a first process of a plurality of processes in the JVM to assign the computing task and assigning the computing task to the first process;
the first process assigning the computing task to a first thread for processing the computing task;
in response to detection of a result of the first thread processing the computing task, the first process invoking native program code via the native program code interface to provide the result to the first address space; and
the invoked native program code providing the result to the first address space.

2. The method of claim 1 further comprising:
the task routing process examining metadata of the computing task, wherein the task routing process determines the first process to assign the computing task based, at least in part, on examining the metadata of the computing task.

3. The method of claim 2, wherein the metadata of the computing task indicates a first class of a plurality of classes of computing tasks and the plurality of processes corresponds to the plurality of classes.

4. The method of claim 3, wherein the plurality of classes corresponds to at least one of a protocol, type of service, or type of processing.

5. The method of claim 2, wherein a header of the computing task comprises the metadata.

6. The method of claim 1 further comprising the first process generating the first thread prior to assigning the computing task to the first thread.

7. The method of claim 1, wherein the first process assigning the computing task to the first thread comprises assigning the first process to the first thread among a plurality of threads of a thread pool.

8. The method of claim 1 further comprising the invoked native program code determining the second address space with a token from the first process, wherein the token was copied with the computing task from the first address space and identifies a process of the first address space.

9. One or more non-transitory machine-readable media having program code for processing computing tasks of various classes offloaded into a first address space from other address spaces of a mainframe environment, the program code to:
register a space switching program call routine with an operating system of the mainframe environment for invocation by processes of the other address spaces to offload computing tasks into the first address space;
determine which class of a plurality of classes is indicated for a computing task offloaded into the first address space in response to detection of the computing task in a first buffer of a Java virtual machine via a native program code interface of the first address space which encompasses the Java virtual machine;
route computing tasks to ones of a plurality of Java processes based, at least in part, on the determined class, wherein each of the plurality of Java processes corresponds to a different one of the plurality of classes;
manage threads for processing computing tasks of one of the plurality of classes; and
return results of computing tasks from the threads to the other address spaces via the native program code interface, wherein the program code to return the results returns the results based, at least in part, on tokens of the computing tasks.

10. The non-transitory machine-readable media of claim 9, wherein the computing task comprises a header that includes the token.

11. The non-transitory machine-readable media of claim 9, wherein the computing task comprises a header that indicates the class of the computing task.

12. The non-transitory machine-readable media of claim 9 further comprising program code for the plurality of Java processes, wherein the program code for each Java process comprises program code to return a computing task result from a thread based, at least in part, on a token corresponding to the computing task result.

13. An apparatus comprising:
a processor; and
a machine-readable medium having program code executable by the processor to cause the apparatus to,
register, with an operating system of a mainframe environment, a space switching program call routine to copy a computing task from a first address space to a second address space in the mainframe environment, wherein a Java virtual machine (JVM) executes within the second address space;
in response to detection of the computing task in the second address space, invoke a native process to send, via a native program code interface, the computing task to a task routing process in the JVM;
in response to detection of the computing task in the JVM, invoke program code for the task routing process to,
determine which class of a plurality of classes is indicated for the computing task,
determine a first process of a plurality of processes in the JVM to assign the computing task based, at least in part, on the first class, and
assign the computing task to the first process;
invoke program code of the first process to assign the computing task to a first thread for processing the computing task; and
in response to detection of a result of the first thread processing the computing task, invoke native program code via the native program code interface to provide the result to the first address space.

14. The apparatus of claim 13, wherein the program code determine which class of a plurality of classes is indicated for the computing task comprises program code executable by the processor to cause the apparatus to:
invoke program code for the task routing process to examine metadata of the computing task for an indication of a class.

15. The apparatus of claim 14, wherein the metadata of the computing task indicates a first class of a plurality of classes of computing tasks and the plurality of processes corresponds to the plurality of classes.

16. The apparatus of claim 14, wherein a header of the computing task comprises the metadata.

17. The apparatus of claim 13, wherein the plurality of classes corresponds to at least one of a protocol, type of service, or type of processing.

18. The apparatus of claim 13, further comprising program code for the first process to generate the first thread prior to the first process assigning the computing task to the first thread.

19. The apparatus of claim 13, wherein the program code of the first process to assign the computing task to the first thread comprises program code to assign the computing task to the first thread among a plurality of threads of a thread pool.

20. The apparatus of claim 13, wherein program code of the first process comprises program code to determine the second address space with a token associated with the computing task, in response to detection of the result.
